(19) United States
(12) Patent Application Publication
(10) Pub. No.: US 2015/0322617 A1
(43) Pub. Date: Nov. 12, 2015

(54) Dryer Exhaust Duct Alarm

(71) Applicants: Thomas J. Asciolla, Monroe, NJ (US); Jack R. Terrazas, San Antonio, TX (US)

(72) Inventors: Thomas J. Asciolla, Monroe, NJ (US); Jack R. Terrazas, San Antonio, TX (US)

(21) Appl. No.: 14/209,277

(22) Filed: Mar. 13, 2014

Related U.S. Application Data
(60) Provisional application No. 61/934,713, filed on Feb. 1, 2014.

(51) Int. Cl. D06F 58/20; F26B 21/12

(52) U.S. Cl. CPC D06F 58/20; F26B 21/12

(57) ABSTRACT

Disclosed is an improved dryer vent alarm system that has an elbow shaped vent conduit attachment that contains sensor(s) for dryer operation and for air flow to enable detection of and input to an alert module for reduced air flow from the dryer that may indicate vent plugging. Embodiments include a dryer vent system comprising: a dryer exhaust conduit attachment having a dryer operation sensor and a flow sensor that communicates with an alert module to provide an indication of reduced or disrupted air flow from a dryer, wherein the exhaust conduit attachment is a rigid or semi-rigid circular elbow shaped conduit, one end adapted to be attached to a dryer outlet and the other end to a conventional vent conduit.

### CROSS REFERENCE TO RELATED APPLICATIONS

This application claims benefit of Provisional Application Ser. No. 61/934,713 filed Feb. 1, 2014, the content, Figures and disclosure of which are incorporated herein by reference in their entirety for all purposes.

### BACKGROUND

1. Field of Invention

This specification relates to the field of dryer safety and more particularly to an alarm for detecting obstructions in a dryer vent.

2. Background

Clothes dryer vents are a necessary part of a drying system. In a typical consumer- or commercial-grade dryer, clothes are dried with heated air. Dry, cool ambient air is pulled into the dryer and heated. The heated air extracts moisture from the wet clothes. The now-moist air must be exhausted from the system and replaced with dry air.

A result of this process is that lint and other flammable material is sometimes extracted from the clothes being dried. This lint can then be expelled with the exhaust air. Most dryers provide a lint trap to capture the bulk of this lint, but the lint traps are imperfect, and some lint will escape into the exhaust vent. If lint builds up, it can decrease the efficiency of the dryer and result in a fire hazard from combustion of the lint.

According to the Consumer Products Safety Commission, clothes dryers are associated with approximately 15,600 fires annually, resulting in 20 deaths and 370 injuries. Periodic inspection and cleaning would greatly reduce the incident of such fires but unfortunately most owners do not see this as a priority. This problem is compounded by the fact that many newer homes tend to have dryers located away from outside walls—in bedrooms, kitchens, bathrooms and hall closets. This results in longer dryer venting conduit hidden in walls and ceilings. The dryer has to work harder to force the air up the wall, across the ceiling to the outside exhaust hood. Commercial dryers and vent systems also experience similar problem. Moreover, some vent system will release hazardous fumes if the vent is clogged.

A reliable and effective alarm system that warns of dryer vent clogs would greatly reduce the dangers of vent clogs and fires.

### SUMMARY

Embodiments of the present invention include an improved dryer vent alarm system that has an elbow shaped vent conduit attachment that contains a sensor(s) for dryer operation and for air flow to enable detection of and input to an alarm system for reduced air flow from the dryer that may indicate vent plugging.

Embodiments of the present invention include a dryer vent system comprising: a dryer exhaust conduit attachment having a dryer operation sensor and a flow sensor that communicates with an alert module to provide an indication of reduced or disrupted air flow from a dryer, wherein the exhaust conduit attachment is a rigid or semi-rigid circular elbow shaped conduit, one end adapted to be attached to a dryer outlet and the other end to a conventional vent conduit.

### BRIEF DESCRIPTION OF THE DRAWINGS

The Figures represent embodiments of the invention and are not intended to be limiting of the scope of the invention.

The Figures represent embodiments of the invention and are not intended to be limiting of the scope of the invention.

FIG. 1 is a perspective view of an embodiment of a dryer exhaust vent alarm sensor module of the invention.

FIG. 2 is another perspective view of an embodiment of a dryer exhaust vent alarm sensor module of the invention.

FIG. 3 is a sectional view of view of an embodiment of a dryer exhaust vent alarm sensor module of the invention.

FIG. 4 is a perspective view of another embodiment of a dryer exhaust vent alarm sensor module of the invention.

FIG. 5 is another perspective view of another embodiment of a dryer exhaust vent alarm sensor module of the invention.

FIG. 6 is a perspective view of an alarm module of an embodiment of the invention.

FIG. 7 is another perspective view of an alarm module of an embodiment of the invention.

FIG. 8 is a block diagram of a dryer system equipped with an exhaust duct alarm system.

### DETAILED DESCRIPTION OF THE EMBODIMENTS

The invention is, in broad scope, a dryer exhaust conduit attachment having a dryer operation sensor and a flow sensor that communicates with an alarm module to provide an indication of reduced or disrupted air flow from the dryer, indicative, inter alia, of lint obstruction in the exhaust conduit.

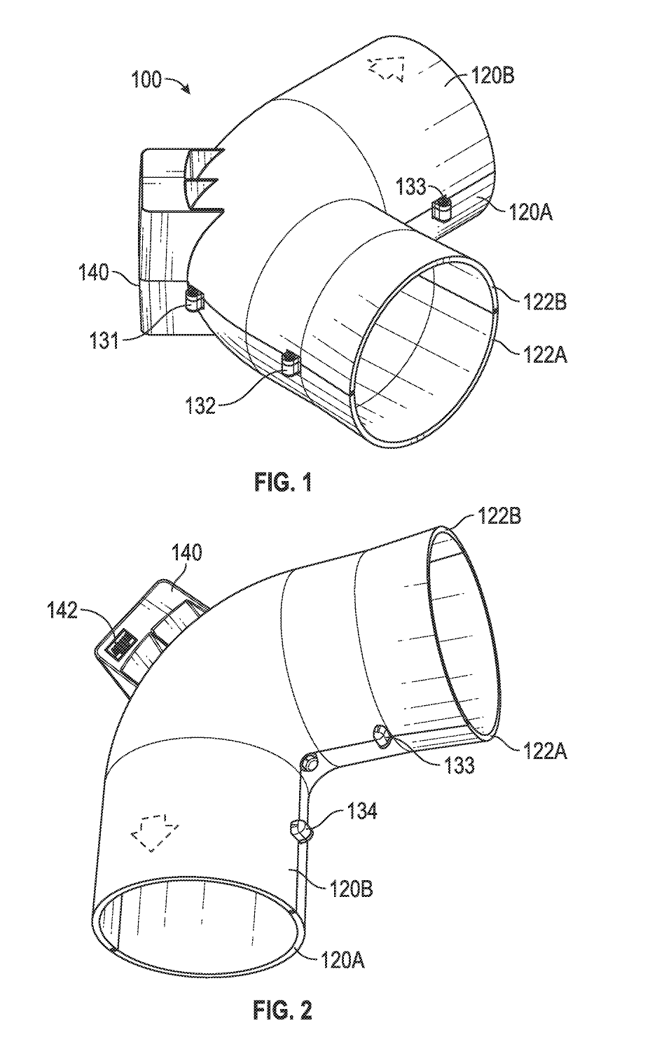

In preferred embodiments, the dryer (such as a clothes dryer) conduit attachment of embodiments of this invention is a rigid or semi-rigid circular conduit shaped as an L (or elbow), one end of which that attaches to a dryer outlet connection and the other end to a conventional vent conduit (normally a flexible conduit) such as that illustrated in FIGS. 1-4. Disposed in the attachment are sensors for detecting operation of a dryer to which it is attached and sensor(s) for determining an indication of air flow rate. The air flow rate provides an indication of whether there is an obstruction to air flow in the conduit. The purpose for measuring an indication of air flow is to provide a signal to an alarm (or other indicator device) of reduced air flow that is indicative of lint buildup (or other obstruction) in the vent line. The L (elbow) configuration of the conduit attachment is especially important. Exhaust vent attachment(s) that are inline (in the same plane) as the dryer vent such as described in U.S. Pat. No. 8,256,133, Sep. 4, 2013, have experienced some difficulties that are overcome with the L (elbow) configured attachment of the present invention. For example, on a very popular model Whirlpool/Kenmore dryer, the motor blower assembly is located in the rear of the dryer, an arrangement that places the blower assembly very close to the internal exhaust vent. The blower wheel that is attached to the motor produces the airflow throughout the dryer system. The blower wheel is constructed with blades/baffles the captures the air and creates the airflow. Because of the location of the blower (near the very back of the dryer), the airflow on these models can be erratic and turbulent. This turbulence can make some mechanical flow sensing means also erratic. This, of course, makes installation more complicated. The elbow configuration of the vent system disclosed in this application captures and calms the air before it contacts the flow sensor means and creates a more even flow, eliminating the need for the extra tubing and eliminates false alarms (a major improvement).

Another advantage of the elbow configuration of the present invention is its space saving capability. Today's laundry rooms are smaller and the need to save space is crucial. Prior art straight line attachments together with vent conduit could require as much as 10 inches of space from the dryer back to a wall. The attachment of this invention requires as little as 5 inches of space behind the dryer and can pivot straight up or 90 degrees left or right. This allows for a versatile and simple installation.

The device of embodiments of the present invention also is easily attached to the dryer vent without special tools or skill. It has, in one embodiment, a tapered flange (122 A and B in FIGS. 1-5) that allows for universal fit onto all dryers. It is tapered in diameter from 104 mm-98 mm, which allows the flange to tighten as you push the elbow onto the dryer vent connection (commercial dryers are larger, usually about six inch nominal diameter). This eliminates the need for an extra sleeve to connect to the dryer vent.

Details of embodiments are set forth herein by way of example to facilitate discussion of the disclosed subject matter. It will be apparent to a person of ordinary skill in the field, however, that the disclosed embodiments are exemplary and not exhaustive of all possible embodiments.

Referring to FIGS. 1 and 2, an embodiment of the invention 100 is displayed. In this embodiment the vent attachment is comprised of sections, 120A and B and 122 A and B. These sections (split design) are attached together (connectors 131, 132, 133 and 134). This sectional arrangement facilitates inspection, repair and replacement of sensors located inside the conduit and is desirable but not essential to the invention.

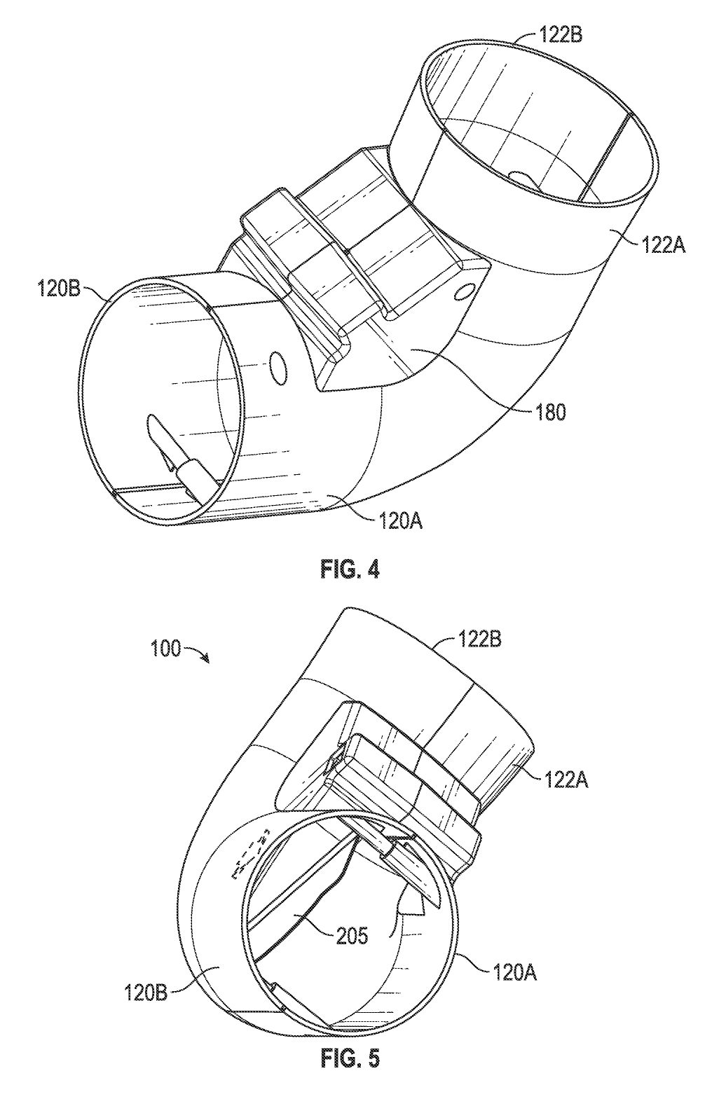

The structure, 100, is essentially a 90° cylindrical elbow (L) shaped conduit. The end of the elbow (where lead line 122A points) is slightly tapered to allow it to fit snugly on dryer vent outlets that may be of different diameters. In general, home dryers have a nominal four inch diameter vent outlet, but commercial dryers have a six inch nominal diameter outlet. Embodiment of the invention will be sized accordingly. Connectors 131-134 are shown as screws but may be any suitable means of connecting the parts together. The parts may be glued or otherwise permanently connected or made as a single structure. Item 140 is housing for components of the dryer operation and flow indication sensor means and for means for communication to an alarm module remote from the vent attachment 100. Item 142 is a port for wired connection. The housing 140 may be located as shown on the outside of the elbow or on the inside of the elbow as shown in FIGS. 4 and 5. It may also be placed on the side of the elbow or in any other convenient location. The location will be determined, inter alia, by the kind of sensors used.

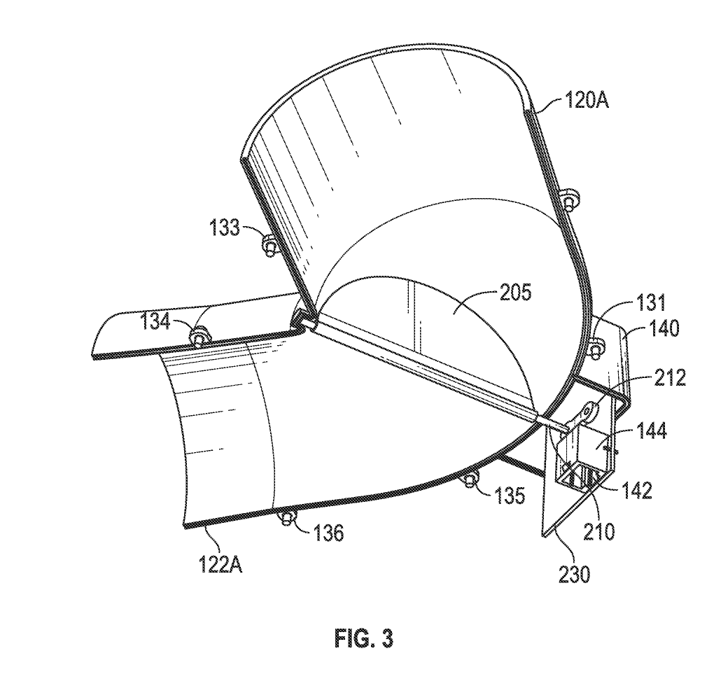

Flow indicator sensors may be any suitable means of detecting air flow but a mechanical displacement flow sensor is a preferred embodiment as it is relatively inexpensive and reliable. A mechanical displacement sensor means is illustrated in the Figures. A lever or flap (205 in FIG. 3) is suspended within the vent attachment 100. In the presence of uninhibited air flow, the lever is substantially displaced from its initial substantially vertical position toward a substantially horizontal or tilted position. But when airflow is inhibited, the flap is not displaced to the same extent as when air flow in normal. A detector detects operation of the dryer. If the dryer operates for a predetermined period of time but the flap is not sufficiently displaced, the sensor communicates a signal to the alarm module for sounding an alarm or other indication of malfunction of the dryer vent system. Other data may also be transmitted, including real-time data over a communication medium.

FIG. 3 shows a lever or flap 205. An axle 210 is provided to which flap 205 is attached and suspended. As is seen in this view, flap 205 may be substantially half-moon shaped, and should be constructed and suspended so as to move freely in conduit 100. The lever (flap) may be of any suitable configuration such as a flat strip, a square or rectangular shape but is preferably a half-moon shape as shown in FIG. 3. A half-moon shape flap disposed in the center of the elbow sits in a more direct flow of air which makes it much more stable and able to pivot in three directions (straight up, 90° right or left of the dryer) for versatile installation. The thickness of the flap 205 is desirably between one-half millimeter and three millimeters. The preferred thickness is approximately one millimeter.

There is also attached to axle 210 a lever 212, which rotates with axle 210. A mounting board 230 is shown, on which electronic components are mounted. The board (such as a Printed Circuit Board Assembly (PCBA)) that is housed within electronics housing 140 contains components of the operation sensor systems as well as components of the flow sensor system. The board will also generally contain the port for wired connection to the alarm module or means to wirelessly transmit signals to the alarm module.

Attached to axle 210 there is a flap 212. The flap (212) holds a magnet that is axial to the flapper axle 210 that activates a REED switch (a switch activated by magnetic force) component on a Printed Circuit Board Assembly (PCBA). This flapper lever is fixed with respect to axle 210, such that when axle 210 rotates, it moves up or down. A member attached to 212 (not shown) moves up or down in part 144. Part 144 has a displacement sensor that detects the location of 144. It may be any type of sensor that detects the displacement of 212 such as a REED switch. In some embodiments, this may be a simple proximity trigger. In those cases, displacement sensor is placed so as to trigger when metallic bar 212 passes through a desired angle.

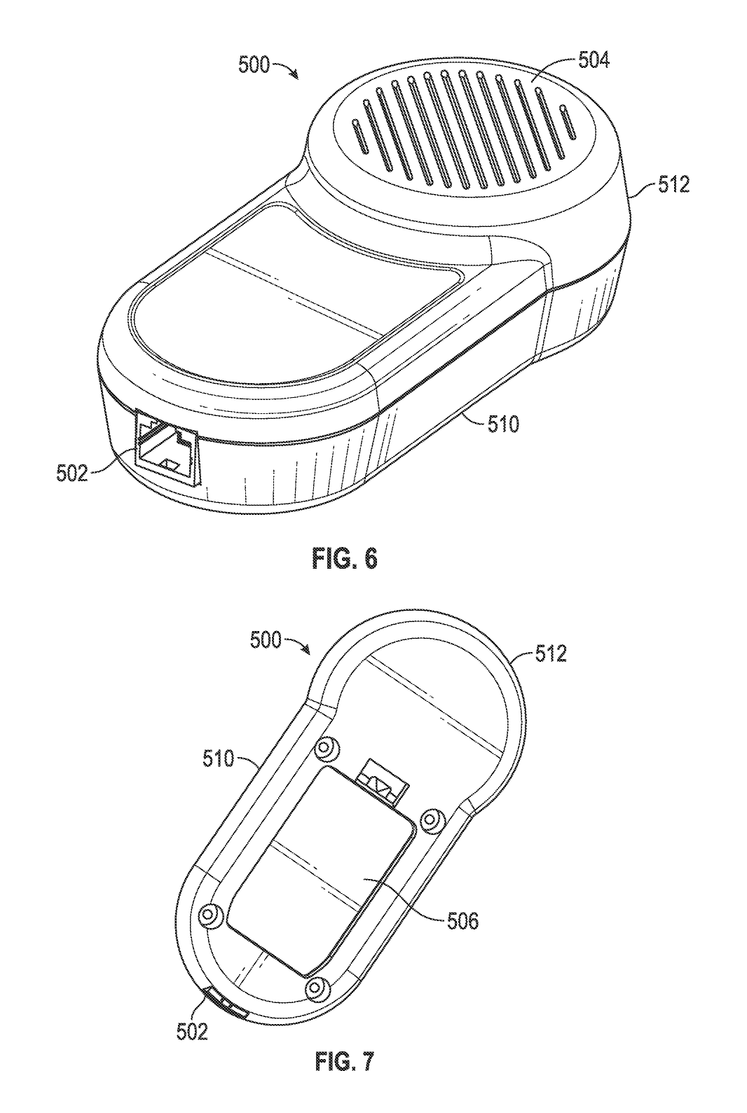

In other embodiments, the displacement sensor 310 (FIG. 6) and lever 212 may be replaced with other angle-sensing means or mechanisms. For example, a high-resolution device such as a synchro may be used.

In nominal operation, displacement sensor 310 will detect that lever 212 is resting at the desired angle (FIG. 6). There can also be seen in these views standoffs 330 and a clip insert, which may be used for attaching electronics housing 140.

### Dryer Operation Sensors

There are many suitable means for detecting dryer operation. In a prototype of an embodiment of the invention a heat sensor is use to determine that the dryer is operating. In this prototype the heat sensor is located on the electronic board (230) within the housing (140) proximate to a small hole in the wall of the elbow attachment. The sensor can detect temperature changes through the hole in the attachment wall. The hole is unlikely to become plugged because the air flow away tends to pull any debris away. The sensor is set at a predetermined temperature that will indicate that heated air from the dryer is passing that is that the dryer is operating. For example, it may be set at about 95° F. to signal that the dryer is on. Controls located on the board will then sense a signal from the flow sensor to determine the lever (flap) location. If the flap is centered and the temperature stays within the proper range the system is working properly and there is no obstruction of flow in the vent line. However, if the temperature is over the predetermined value (e.g. 95° F.) and the location of the flap is not normal the alarm will be triggered by an appropriate signal and the alarm or alert will activate (for example, in about 2:45 seconds-30 seconds). Optionally, the heat sensor may also have a high temperature setting feature that will trigger an alarm if the exhaust temperature exceeds a second predetermined temperature, for example about 185° F. or higher.

In other embodiments a microphone is used to determine if the dryer is operating. The microphone will detect the noise of the operating dryer and activate a signal that is transmitted to the alarm module. For example, the microphone may be mounted on the inside wall of the elbow conduit and sit in a direct path of the airflow. It is within the grasp of persons having ordinary skill in the art to select from a number of available microphone styles, including such well known examples as capacitive, electret, piezoelectric, and carbon microphones, among others. It will also be appreciated that the intended function of the microphone is to detect the operation of the dryer and thus it can be interchanged with other types of dryer operation detectors. For example, in some embodiments, an inductive clamp may be used as a dryer operation sensor. In those cases, the clamp may be attached to the dryer's power supply cord, so that when current flows through the cord to the dryer, it is detected that the dryer is operating. In other embodiments, a dryer exhaust vent alarm may be installed by the original equipment manufacturer (OEM) of a dryer as part of the original equipment. In those cases, the dryer operation sensor may be provided as an explicit signal indicating that the dryer is operating. Knowledge of other means of detecting dryer operation will be well within the skill of those skilled in the art.

### Flow Sensors

A variety of devices are available to measure flow. Options include sensors using pitot tubes, orifice plates, venturis, Coriolis, vortex shedding, turbine, magnetic, ultrasonic, positive displacement and thermal dispersion. Displacement mechanical sensing systems as described above for one embodiment of the invention has the advantage of being both inexpensive and reliable. Displacement sensors are the simplest form of monitoring airflow. In a prototype as described above a flap is placed into the airflow stream and is displaced when the airflow changes. This system is very effective in monitoring airflow in many different applications in HVAC and building duct systems. A sensor is placed onto the shaft of the flap and its position is detected with another sensor to monitor the position of the shaft. Once the position of the shaft is out of the normal range the airflow is considered restricted.

However, other means are within the scope of the invention and provide options that may meet requirement that are not necessarily met by the displacement mechanical system. One suitable choice is an averaging pitot tube. It measures differential pressures (dPs) created by an obstruction in the flow path across multiple points within a duct, to come up with an average flow rate. (In contrast, a standard pitot-tube-based device senses pressure at a single point selected to represent the average flow velocity.) This flow rate is a function of K, a flow coefficient, and the square root of dP. The K factor is the ratio of the actual flow rate to the calculated (theoretical) flow rate. The dP is proportional to the square of the fluid velocity through the duct. Averaging-pitot-tube-based measurement provides the highest level of reliability and accuracy as well as least amount of obstruction and energy loss, and is less expensive than other technologies.

The Series JFM-P FloSen® Airflow Measuring Probes also provide accurate, repeatable measurement of air flow. Its patented elliptically-shaped sensor design with improved aerodynamic characteristics outperforms more traditional devices. It is designed to maintain a constant parallel airflow pattern over the static sensing ports for more accurate, steady signals under all duct conditions. The elimination of separation results in a stabilized static pressure signal, helping to eliminate “hunting” during fan control. FloSen® Airflow Probes utilize a unique in-line groove for total pressure sensing and dual ports for static pressure sensing which produces a higher differential pressure for very low velocity measurements. The total and static pressure measuring points are distributed for equal-area averaging of flows resulting in improved accuracy and reliability. This design permits accurate and stable measurement in highly turbulent flow locations with directional pitch and yaw varying up to 20 degrees without the need for air flow straightener means that restrict airflow and can easily become clogged. The elliptical shape of the FloSen® Airflow Probes allows air to glide unrestricted around the aerodynamically designed sensors and offers the lowest pressure drop of any airflow measuring device available minimizing Dryer & HVAC operating costs. Moreover, the FloSen® Airflow Probes have been designed for easy installation and maintenance. The insertion-style probes can be completely installed from outside the duct. The quantity of FloSen® Airflow Measuring Probes selected for each duct size is based on ASHRAE and AMCA standards to produce assured airflow measuring accuracy over a flow turn-down ratio of 17:1. See http://www.sensocon.com/airflow-probes-JFM.html

In another embodiment airflow is detected by an thermistor airflow sensor, housed inside of the 90° elbow that detects the speed/movement of air. Its design is based on a heated thermistor which monitors the airstream and detects loss of reduction of airflow due to obstruction of air inlets/outlets. The thermistor temperature and, therefore, its resistance are affected by changes in air velocity. The SAF thermistor is part of a sensing bridge which compares its own resistance against a reference circuit and determines the air velocity at which the device must trigger the output. As the air moves over the sensor the sensor converts information which is read by a main circuit board which determines the proper predetermined zone in which the airflow is in. The sensor can be any shape; it can be a disc, probe or directly attached to the circuit board. The sensor may also have a temperature sensor that determines the air temperature inside of the duct system and relates the information back to the main circuit board. Thus a thermistor may be selected to function as both operation sensor and flow sensor. If the detected airflow is found to be too low, or the temperature too high, or any combination of the two, a signal is transmitted to an alarm module. The signal may be communicated by a wired or wireless transmission. A wireless signal may be sent through a network, cloud, internet, alarm network, computer, cell phone etc.

Another suitable sensor is the advanced SAF Series Airflow Switch that provides early detection and protection from overheating in mainframe computers and peripherals, large power supplies; HVAC applications, medical diagnostic equipment, and other complex electronic systems requiring forced air cooling. Its design is based on a heated thermistor which monitors the airstream and detects loss of reduction of airflow due to fan failure, clogged screens or filters and obstruction of air inlets/outlets. The thermistor temperature and, therefore, its resistance are affected by changes in air velocity. The SAF thermistor is part of a sensing bridge which compares its own resistance against a reference circuit and determines the air velocity at which the device must trigger the output. See http://www.radiodetection.com/products.

These sensor units offer a sealed sensor which will not clog, that measures airflow, it is small in size will fit into small ducts without restricting airflow. Other flow sensors will be within the knowledge of those skilled in the art and in some cases sensors that are apparently uneconomic will become more cost effective in the future. Other sensors will also become available that is considered to be within the scope of the invention.

The sensing devices described above will be connected to an alarm module either by wired or wireless connection. The alarm module may be located with the sensors on the elbow conduit but is preferably located remote from the elbow vent attachment. For example, in many applications the alarm module will be wire connected to the sensors board and located on a wall above the dryer.

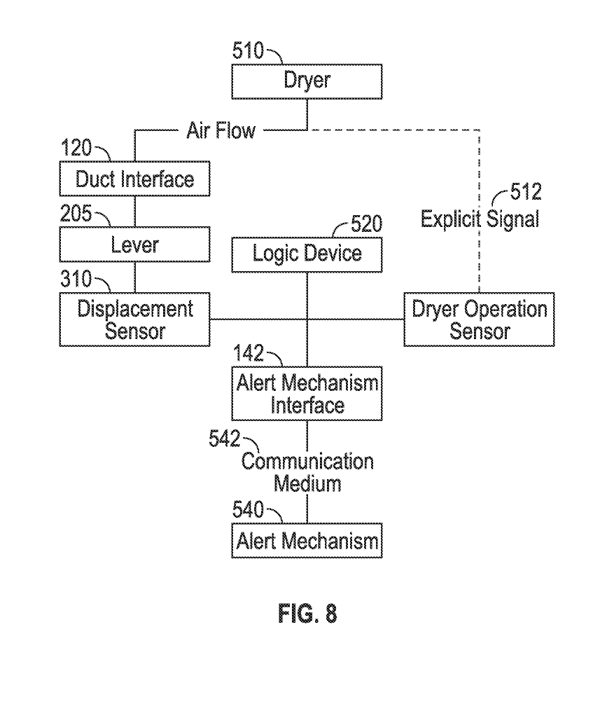

FIG. 8 is a block diagram showing the interconnections between components of a dryer exhaust duct alarm 100 in an embodiment of the invention. Dryer 510 (not shown in other drawings) provides air flow into elbow vent attachment. Air flow 270 strikes flap 205, displacing it through an angle. Displacement sensor 310 detects the angular displacement of flap 205. A dryer operation sensor may or may not be directly coupled to dryer 510. The dryer operation sensor operates to detect that the dryer is operating. Logic device 520 (not shown in drawings) may be any analog or digital device capable of processing the necessary signals. Logic device 520 receives from dryer operation sensor a signal indicating that dryer 510 is operating. Logic device 520 then checks the indication signal of displacement of lever 205 via displacement sensor 310. If dryer 520 has been operating for a sufficient time, but the angular displacement of lever 200 is still inadequate, then logic device 520 generates an alarm signal condition and may provide data to alarm module interface 142. Alarm module interface 142 may connect logic device 520 to alert mechanism 540 via a communication medium 542. Communication medium 542 may be a medium such as a simple wired signal, a serial or parallel interface, an infrared interface, or a wired or unwired internet protocol interface. If alert mechanism 540 receives an alarm condition from logic device 520, it responds accordingly. For example, in some embodiments, alert mechanism 540 may include a combination of audible and visible alarms. In other embodiments, and particularly those where dryer exhaust duct alarm is provided by the OEM, the alert module may include a display that includes more detailed data, including real-time and trending data, which may be displayed graphically. In yet other embodiments, alert mechanism interface 142 may be an interface capable of connecting to an internet protocol (IP) or other similar network. In those cases, data may be provided to other network-aware devices, including computers, e-mail systems and hand-held wireless devices. The trending data and/or alarm condition may be conveyed graphically, or through such services as an e-mail sent to a user's e-mail account or a text message sent to a user's mobile phone.

FIGS. 6 and 7 illustrate embodiments of suitable alarm modules. The alarm, 500, is designed to be mounted on a wall or other suitable location near a dryer and attached to the dryer alarm electronic means by a cable that attaches at 502. The body 510 houses the components. Item 504 is the speaker face and 512 the speaker housing. Item 506 is an opening lid for batteries. This is only one embodiment and it will be recognized that other configuration are suitable. A wireless or internet connection would not have the appearance of the embodiments of FIGS. 6 and 7.

The invention is also, in some embodiments, a method of providing an alert or alarm of obstruction in a dryer vent. The method comprises providing an duct alarm system in a dryer duct as described above that has sensors to detect dryer operation and air flow velocity; means to translate signals from the sensors to means for providing visual or audible alarm(s), and in some embodiment communication with the internet of other means to provide a signal remotely as by cell phone and the like.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

1. A dryer vent system comprising:
a dryer exhaust conduit attachment having a dryer operation sensor or sensors and a flow sensor or sensors that communicates through a communication link with an alert module to provide an indication of reduced or disrupted air flow from a dryer, wherein the exhaust conduit attachment is a rigid or semi-rigid circular substantially 90° elbow shaped conduit, one end of the elbow adapted to be attached to a dryer outlet and the other end to a conventional vent conduit and wherein at least one flow sensor is disposed substantially in the angle of the elbow conduit.

2. The dryer vent system of claim 1 also comprising an alert means that communicates with the dryer sensor(s) and flow sensor(s).

3. The dryer vent system of claim 1 wherein the flow sensor is a mechanical displacement system comprising a flap disposed inside the elbow conduit.

4. The dryer vent system of claim 1 also comprising a housing unit located on the outside of the elbow conduit in which is located means for detecting and communicating signals from the flow and dryer operation sensors to an alarm module.

5. The dryer vent system of claim 1 wherein the dryer operation sensor is selected from the group consisting of a microphone, a heat detection device and an inductive detection unit that surrounds the electrically connection cord to the dryer.

6. The dryer vent system of claim 1 wherein the flow sensor is selected from the group consisting of sensors using pitot tubes, orifice plates, venturi, coriolis, vortex shedding, turbine, magnetic, ultrasonic, thermistors and positive displacement and thermal dispersion.

7. The dryer vent system of claim 1 wherein the end of the conduit adapted to be attached to a dryer vent outlet is tapered.

8. The dryer vent system of claim 1 wherein the communication link from the dryer vent sensor to an alarm module is wired or wireless.

9. The dryer vent system of claim 1 wherein the elbow shaped conduit comprises components capable of being assembled and dissembled.

10. The dryer vent system of claim 1 wherein the flow sensor comprises a flap disposed inside the conduit that is attached to an axle that is, in turn, attached to a displacement detection means.

11. A method of detecting reduced air flow in a dryer comprising providing in the vent system of a dryer a dryer exhaust conduit and an attachment having a dryer operation sensor or sensors and a flow sensor or sensors that communicates through a communication link with an alert module to provide an indication of reduced or disrupted air flow in the exhaust conduit wherein the exhaust conduit attachment is a rigid or semi-rigid circular elbow shaped conduit, one end adapted to be attached to a dryer outlet and the other end to a conventional vent conduit.

12. The method of claim 11 wherein the dryer operation sensor is selected from the group consisting of a microphone, a heat detection device and an inductive detection unit that surrounds the electrically connection cord to the dryer and the flow sensor is selected from the group consisting of sensors using pitot tubes, orifice plates, venturis, Coriolis, vortex shedding, turbine, magnetic, ultrasonic, thermistors and positive displacement and thermal dispersion.

13. The method of claim 11 wherein the flow sensor is a mechanical displacement system comprising a flap disposed inside the elbow conduit.

14. The method of claim 11 wherein the communication link from the dryer vent sensor to an alarm module is wired or wireless.

15. The method of claim 11 wherein the communication link from the dryer vent sensor to an alarm module is through the internet to enable remote access and control.
